(19) United States
(12) Patent Application Publication
(10) Pub. No.: US 2009/0216592 A1
(43) Pub. Date: Aug. 27, 2009

(54) System And Method For Identifying Network Click

(75) Inventor: Guodong ZHANG, Shenzhen City (CN)

Correspondence Address: HARNESS, DICKEY & PIERCE, P.L.C., P.O. BOX 828, BLOOMFIELD HILLS, MI, 48303, US

(73) Assignee: Tencent Technology (Shenzhen) Company Limited, Shenzhen City (CN)

(21) Appl. No.: 12/434,759

(22) Filed: May 4, 2009

Related U.S. Application Data
(63) Continuation of application No. PCT/CN2007/071013, filed on Nov. 2, 2007.

(30) Foreign Application Priority Data
Nov. 8, 2006 (CN) 200610138617.5

(51) Int. Cl. G06Q 10/00; G06Q 50/00; G06F 17/00

(52) U.S. Cl. 705/7; 715/205; 713/153

(57) ABSTRACT

The present invention discloses a system for identifying a network click. The system includes: a parsing server, adapted to provide, after a page is impressed, impression information of the impressed page for an identifying server; a clicking server, adapted to provide, after the impressed page is clicked, click information for the identifying server according to the click; the identifying server, adapted to determine whether the impression information and the click information meet a corresponding relationship, determine the click as an effective click if the impression information and the click information meet the corresponding relationship, and determine the click as a vicious click if the impression information and the click information do not meet the corresponding relationship. The present invention also provides a method for identifying a network click. The solution of the present invention can dramatically increase the precision of identifying vicious clicks.

### CROSS-REFERENCE TO RELATED APPLICATIONS

This application is a continuation of International Application No. PCT/CN2007/071013, filed Nov. 2, 2007. This application claims the benefit and priority of Chinese Application No. 200610138617.5, filed Nov. 8, 2006. The entire disclosures of each of the above applications are incorporated herein by reference.

### FIELD

The present disclosure relates to network application technologies, and more particularly, to a system and method for identifying a network click.

### BACKGROUND

This section provides background information related to the present disclosure which is not necessarily prior art.

Currently, along with continuous development of Internet technologies, various network applications are booming. Among current network applications, there is usually a statistical requirement for network clicks. For example, there may be a statistical requirement for the number of clicks of an online advertisement or for various online surveys, etc. For description convenience, the online advertisement is taken as an example for describing the statistic of the network clicks.

The online advertisement is an advertisement published through network media, and usually includes advertisements published on network media, such as websites and instant messengers. A character link and a banner are main formats of the online advertisement. The online advertisement generally uses image files in a GIF format. Besides the general GIF format, Rich Media emerged newly may endue the Banner with stronger expressive force and interactive contents, and however generally requires a user to use Browser Plug-in to support the Rich Media.

Along with the popularization of the Internet and fast development of information technologies, the online advertisements are booming at a speed higher than that of conventional media advertisements. In conventional media advertisements (e.g. TV advertisements), the audience rating is an effective way for indicating the effect of the advertisements. In the online advertisements, besides the impression amount of an advertisement which is used to indicate the effect of the advertisement, more and more advertisement clients hope to learn how many people are interested in the advertisement. Generally, if a user is interested in the advertisement, the user will click the advertisement, thereby generating a network click event. During a time period, after seeing the online advertisement in a website page, the user clicks the advertisement to open an advertisement linkage page. This procedure is referred to as an effective network click, called an effective click for short.

Every user on the Internet can receive online advertisements generally. But the users on the Internet are diversified. Besides normal activities of clicking an advertisement, i.e. effective clicks, it is still possible that some people having ulterior motives click one advertisement for many times. Even worse, it is possible that some “program enthusiasts” (hackers) program relevant codes to click the advertisement using a program. In addition, an advertisement market is a commercial market space, where there are various benefit groups. Some benefit groups, e.g. advertisement agents, may hire some people to viciously click the advertisement in order to increase the number of click times of the advertisement, thereby increasing their own income. This procedure is called vicious network click, called vicious click for short. The familiar vicious click includes: clicking on one advertisement for many times during a short period of time, or automatically initiating a click request using software such as Hothit.

At present, technologies for identifying a vicious click in the prior art mainly include:
(1) Restricting a maximum number of click times for a single IP address during a time unit,

In this technology, each clicking user has an IP address, thus the IP address of each clicking user may be recorded. Then, it is determined whether the number of click times of the user with the IP address exceeds a predefined value. If the number of click times exceeds the predefined value, it is determined that the clicks are vicious. For example, it is configured that clicks are vicious if the number of click times exceeds 100 during 5 minutes, and it is supposed that a user with IP address 11.22.33.44 has clicked the advertisement more than 100 times during 5 minutes, the clicks may be recorded as only one time of effective click, the other clicks may be regarded as vicious clicks and are not counted.
(2) Restricting a maximum number of click times for a single user during a time unit

In this technology, a user Identity ID may be configured in user cookie when an advertisement is played. The user ID is a unique identity of the user. When the user clicks the advertisement, the user ID is recorded. It is determined whether the number of click times of the user exceeds a predefined value during a time unit. If exceeds, the clicks are regarded as vicious clicks. For example, it is configured that clicks are determined as vicious clicks if the number of click times exceeds 10 times during 5 minutes, and if a user acdeefg123456 has clicked the advertisement for more than 10 times during 5 minutes, only one effective click is recorded and the other clicks are regarded as vicious clicks and are not counted.

However, the above technologies for identifying vicious clicks only define some parameters by rote, e.g. the time unit and the maximum number of click times, for restriction. Values of the parameters are generally figured out according to experience without considering the impression process of the advertisement or the click habit of the user. With the development and publication of the technologies, many people having ulterior motives can learn these technologies, and find out some methods against the current technical restriction easily.

Obviously, the above analysis regarding the online advertisement is also applicable to technologies for identifying any other network clicks such as online surveys.

Therefore, in order to ensure the accuracy of identifying a network click and improve the precision of identifying vicious clicks, it is necessary to take the impression process and the click habit of the user into account while identifying a click.

### SUMMARY

This section provides a general summary of the disclosure, and is not a comprehensive disclosure of its full scope or all of its features.

In view of the above, an objective of embodiments of the present is to provide a system for identifying a network click, which takes an impression process of an advertisement and a click habit of a user into account during the process of click identifying so as to increase the precision of identifying a vicious click.

Another objective of the embodiments of the present invention is to provide a method for identifying a network click, which takes an impression process of an advertisement and a click habit of a user into account during the process of click identifying so as to increase the precision of identifying a vicious click.

To achieve the above objectives, the solution of the present invention is as follows:

A system for identifying a network click includes: a parsing server, a clicking server and an identifying server; the parsing server is adapted to provide, after a page is impressed, impression information of the impressed page for the identifying server; the clicking server is adapted to provide, after the impressed page is clicked, click information for the identifying server according to the click; and the identifying server is adapted to determine whether the impression information and the click information meet a corresponding relationship, determine the click as an effective click if the impression information and the click information meet the corresponding relationship, and determine the click as a vicious click if the impression information and the click information do not meet the corresponding relationship.

A method for identifying a network click includes: providing, after a page is impressed, impression information of the impressed page; providing, after the impressed page is clicked, click information according to the click; determining whether the impression information and the click information meet a corresponding relationship; if the impression information and the click information meet the corresponding relationship, determining the click as an effective click; otherwise, determining the click as a vicious click.

It can be seen from the above solution that, compared with prior art, the impression process and click habit of the user are considered while identifying the network click. A click is identified according to an inherent corresponding relationship between the impression information and the click information. Therefore, the precision for identifying a vicious click is increased.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating a system for identifying a network click according to the present invention.

FIG. 2 is a schematic diagram illustrating a system for identifying a network click according to a first embodiment of the present invention.

FIG. 3 is a flowchart illustrating a method for identifying a network click according to the first embodiment of the present invention.

FIG. 4 is a schematic diagram illustrating a system for identifying a network click according to a second embodiment of the present invention.

FIG. 5 is a schematic diagram illustrating a system for identifying a network click according to a third embodiment of the present invention.

FIG. 6 is a schematic diagram illustrating a system for identifying a network click according to a fourth embodiment of the present invention.

FIG. 7 is a schematic diagram illustrating a system for identifying a network click according to a fifth embodiment of the present invention.

FIG. 8 is a schematic diagram illustrating a system for identifying a network click according to an embodiment of the present invention.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

Embodiments of the present invention will be described in detail hereinafter with reference to accompanying drawings.

According to the impression process and click habit of the user, it can be learned that there is regularity between the impression information and the click information of a page, and the regularity may be used to identify whether a click is a vicious click or not. The regularity is that the impression time of the page should be earlier than the click time of the page and that the impression user ID of the page should be consistent with the click user ID of the page.

In particular, the impression and click processes of the page are as follows:

1) First, the user opens the page and the page is impressed. Then the user browses the page and clicks the page. After receiving the click, a click identification system determines whether the click is an effective click or a vicious click. If the click is an effective click, the click may be counted during subsequent operations so as to learn the impression effect of the page. Each click on the page happens after the user sees the page. Therefore, the impression time of the page must be earlier than the click time of the page. Any click happening before the impression time of the page is regarded as an ineffective click or vicious click.

2) Sometimes, the page is not placed where the user browses the needed content information usually, especially for an advertisement page. Therefore, after the page is impressed, the user generally sees the page a time period later. Therefore, the browsing habit of a normal user may be: the user sees the page information incidentally after browsing content information of a website page and clicks the page if the user is interested in the page information. Therefore, the click time of the page should be later than the impression time of the advertisement and should have a delay.

3) The user browsing the page and the user clicking the page are indefinitely the same one. Therefore, the impression user ID of the page is indefinitely consistent with the click user ID of the page.

In embodiments of the present invention, the above impression process and the click habit of the user are adequately considered while identifying a network click. Embodiments of the present invention determine a click as an effective click or a vicious click according to the inherent corresponding relationship between the impression information and the click information.

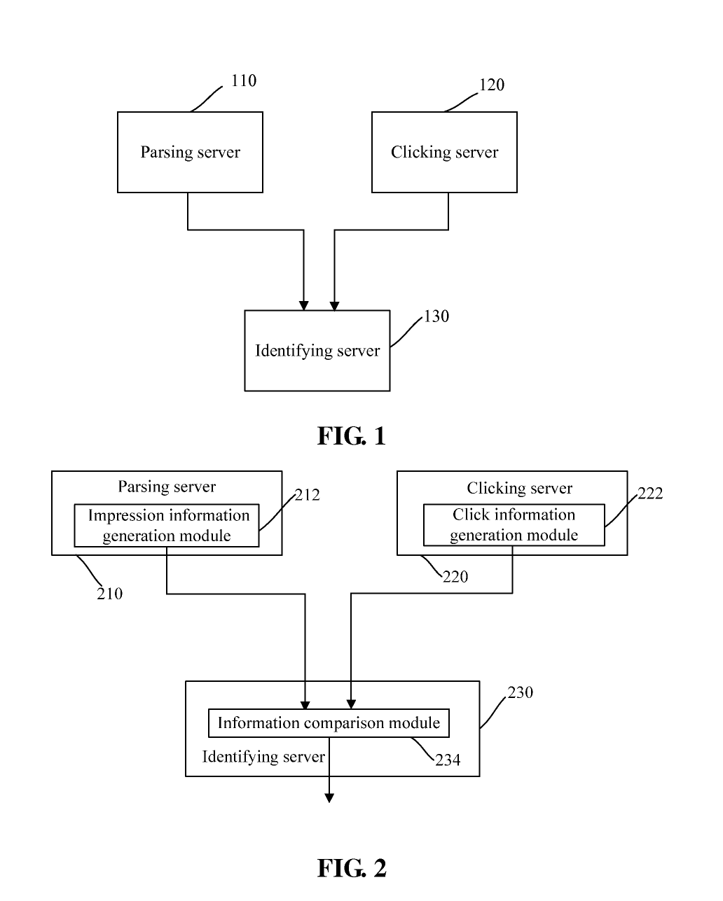

FIG. 1 is a schematic diagram illustrating a system for identifying a network click according to the present invention. As shown in FIG. 1, the system includes: a parsing server 110, a clicking server 120 and an identifying server 130.

The parsing server 110 is adapted to provide, after a page is impressed, impression information of the impressed page to the identifying server 130.

The clicking server 120 is adapted to provide, after the impressed page is clicked, click information to the identifying server 130 according to the click.

The identifying server 130 is adapted to determine whether the impression information and the click information meet a corresponding relationship, determine the click as an effective click if the impression information and the click information meet the corresponding relationship, and determine the click as a vicious click if the impression information and the click information do not meet the corresponding relationship.

Hereinafter, the system for identifying the network click will be described in detail with reference to several embodiments.

### A First Embodiment

FIG. 2 is a schematic diagram illustrating a system for identifying a network click according to the first embodiment of the present invention. As shown in FIG. 2, the system includes: a parsing server 210, a clicking server 220 and an identifying server 230.

The parsing server 210 includes an impression information generation module 212, adapted to provide impression information of an impressed page for an information comparison module 234 of the identifying server 230.

The clicking server 220 includes a click information generation module 222, adapted to provide click information of the impressed page for the information comparison module 234 of the identifying server 230.

The identifying server 230 includes the information comparison module 234, adapted to determine whether the impression information and the click information meet a predefined corresponding relationship, determine the click as an effective click if the impression information and the click information meet the corresponding relationship, and determine the click as a vicious click if the impression information and the click information do not meet the corresponding relationship.

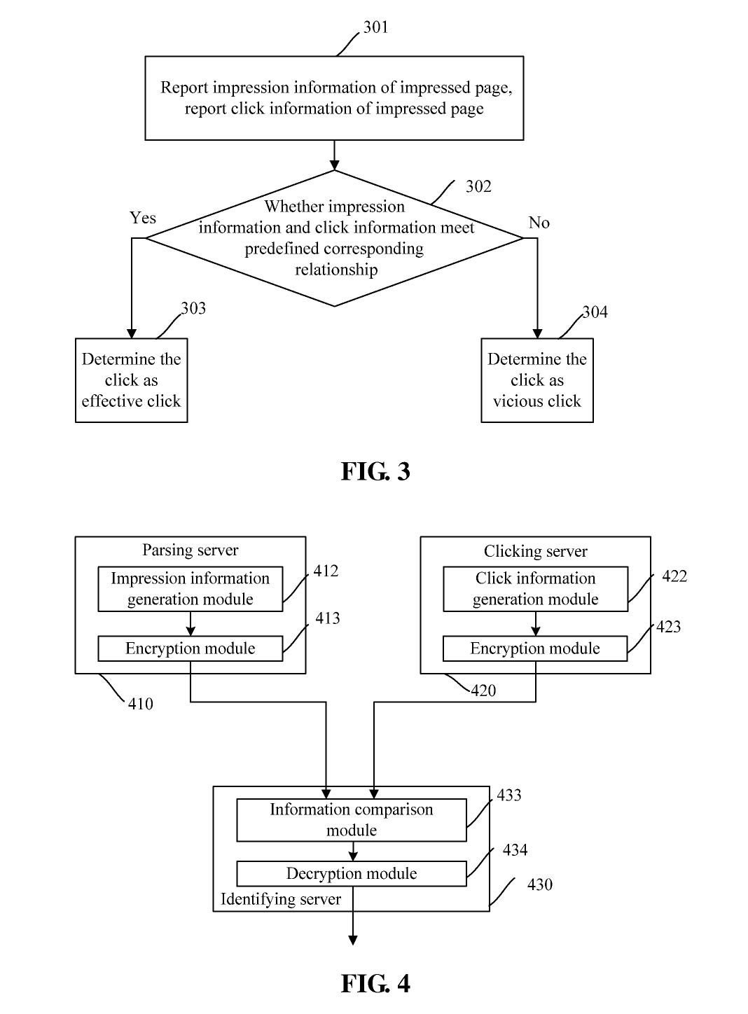

FIG. 3 is a flowchart illustrating a method for identifying a network click according to the first embodiment of the present invention. As shown in FIG. 3, the method includes the following.

Block 301: After a page is impressed, impression information of the page is reported; after the impressed page is clicked, click information of the impressed page is reported according to the click.

Block 302: It is determined whether the impression information and the click information meet a predefined corresponding relationship. If the impression information and the click information meet the corresponding relationship, proceed to Block 303, otherwise, proceed to Block 304.

Block 303: The click is determined as an effective click.

Block 304: The click is determined as a vicious click.

In particular, in embodiments of the present invention, the impression information may be impression time of the page, and accordingly the click information is click time of the impressed page. Whether the click is effective may be determined according to the principle that the impression time of the page is definitely earlier than the click time of the impressed page. In this case, Block 302 includes: determining whether the click time of the impressed page is later than the impression time of the page; if later, proceeding to Block 303 in which the click is determined as an effective click; otherwise, proceeding to Block 304 in which the click is determined as a vicious click.

It takes some time to download a website page and it also takes some time before the user sees the impressed page, the time may be a reasonable attribute value of the user. Therefore, Block 302 preferably includes: determining whether the click time of the impressed page is later than the impression time by a predefined interval; if later, proceeding to Block 303 in which the click is determined as an effective click; otherwise, proceeding to Block 304 in which the click is determined as a vicious click.

In embodiments of the present invention, the impression information may be the impression user ID of the page instead. The impression user ID is a user ID set in user cookie when the advertisement is impressed. The impression user ID is a unique identify of the user displaying the advertisement. When the impression information is the impression user ID of the page, the click information is the click user ID of the impressed page. The click user ID of the impressed page is a user ID set in the user cookie when the user clicks the advertisement. The click user ID is a unique identify of the user clicking the advertisement. Whether the click is a vicious click or not may be determined according to the principle that the impression user ID is definitely the same as the click user ID. In this case, Block 302 includes: determining whether the impression user ID and the click user ID are the same one; if the same, proceeding to Block 303 in which the click is determined as an effective click; otherwise, proceeding to Block 304 in which the click is determined as a vicious click.

In embodiments of the present invention, the impression information may be the impression time as well as the impression user ID of the clicked page. In this case, the click information may be the click time and the click user ID. According to the principle that the impression time of the clicked page is definitely earlier than the click time of the impressed page and the principle that the impression user ID is definitely the same as the click user ID, whether the click is a vicious click or not may be determined. In this case, Block 302 includes: determining whether the click time is later than the impression time and whether the impression user ID is the same as the click user ID; if the click time is later than the impression time and the impression user ID is the same as the click user ID, proceeding to Block 303 in which the click is determined as an effective click; otherwise, proceeding to Block 304 in which the click is determined as a vicious click.

Similarly, it takes some time to download a website page and it also takes some time before the user sees the impressed page, and the time should be a reasonable attribute value of the user. In this case, Block 302 includes: proceeding to Block 303 in which the click is determined as an effective click if the click time is later than the impression time and the delay meets a predefined time condition and the impression user ID is the same as the click user ID; otherwise, proceeding to Block 304 in which the click is determined as a vicious click.

In embodiments of the present invention, the impression information may also be an impression KEY which is a unique, encrypted and reliable value generated by a certain algorithm for the impression action of the clicked page of the user according to information such as the impression time of the clicked page and the impression user ID of the clicked page. In this case, the click information may be a click KEY which is a unique, encrypted and reliable value generated by a certain algorithm for the click action of the user according to information such as the click time of the impressed page and the click user ID of the impressed page. Then, whether the click is a vicious click is determined according to a certain KEY algorithm. In this case, Block 302 includes: proceeding to Block 303 in which the click is determined as an effective click if the impression KEY and the click KEY comply with the KEY algorithm; otherwise, proceeding to Block 304 in which the click is determined as a vicious click.

### A Second Embodiment

Preferably, in order to ensure information security, the impression information and the click information may be encrypted on basis of the first embodiment. FIG. 4 is a schematic diagram illustrating a system for identifying a network click according to the second embodiment of the present invention. As shown in FIG. 4, the system includes: a parsing server 410, a clicking server 420 and an identifying server 430.

The parsing server 410 includes an impression information generation module 412 and an encryption module 413. The impression information generation module 412 is adapted to provide impression information of an impressed page for the encryption module 413. The encryption module 413 is adapted to encrypt the impression information of the impressed page sent by the impression information generation module 412, and send the encrypted impression information to an information comparison module 434 of the identifying server 430.

The clicking server 420 includes a click information generation module 422 and an encryption module 423. The click information generation module 422 is adapted to provide click information of the impressed page for the encryption module 423. The encryption module 423 is adapted to encrypt the click information sent by the click information generation module 422, and send the encrypted click information to the information comparison module 434 of the identifying server 430.

The identifying server 430 includes a decryption module 433 and the information comparison module 434.

The decryption module 433 is adapted to decrypt the encrypted impression information and the encrypted click information, and send the decrypted impression information and the decrypted click information to the information comparison module 434 for determining. Certainly, in practical applications, two decryption modules may be configured in the identifying server 430 respectively for decrypting the encrypted impression information from the parsing server 410 and the encrypted click information from the clicking server 420.

The information comparison module 434 is adapted to determine whether the impression information and the click information meet a predefined corresponding relationship; determine the click as an effective click if the impression information and the click information meet the corresponding relationship, and determine the click as a vicious click if the impression information and the click information do not meet the corresponding relationship.

As shown in FIG. 3, in this embodiment, the method may further include encrypting the impression information before reporting the impression information of the clicked page in Block 301. And the method may also include encrypting the click information before reporting the click information of the impressed page in Block 301. Accordingly, the method may further include decrypting the impression information and the click information before determining whether the impression information and the click information meet the corresponding relationship in Block 302.

Similarly to the first embodiment, in the second embodiment, the impression information may be the impression time of the page and the click information is the click time of the impressed page. The impression information may also be the impression user ID of the impressed page and the click information is the click user ID of the impressed page. The impression information may also be the impression time of the clicked page and the impression user ID of the clicked page; and the click information is the click time of the impressed page and the click user ID of the impressed page. The impression information may also be the impression KEY generated according to the impression time and impression user ID of the impressed page using a certain algorithm; and the click information is the click KEY generated according to the click time and the click user ID of the impressed page using a certain algorithm.

### A Third Embodiment

In this embodiment, preferably, the method may further include determining whether Referer information of a click request is legal after checking the impression information and the click information. If it is determined that the Referer information is legal, the click is regarded as an effective click; otherwise, the click is regarded as a vicious click.

When a user visits a Web server and requests a page, there may be information called an HTTP Request Header in an HTTP Request sent by a browser of the user. The HTTP Request Header includes some information fields of a user request, e.g. a browser edition of the host of the user sending the HTTP Request, a user language, a user operation system platform, a document name requested by the user, and Referer information. The information is transmitted in the form of variable names/variable values. Among the information, the Referer information contains a Uniform Resource Locator (URL) address of the last page of the browser when a client requests a page. For example, if the user visits page A and clicks a hyperlink of page B on page A, the HTTP Request visiting page B includes a Referer field which contains such information as “this request is from page A”. If a request is not from a certain page, but from entering the URL address of page A in the address column of the browser to visit page A, the HTTP Request does not include the Referer field. The Referer field helps to determine whether a network click is from a designated page or other websites.

When the user clicks the impressed page and jumps to a designated page, the Referer information contained in the HTTP Request should be equal to the URL address for page impression. In this case, the Referer information is regarded as legal.

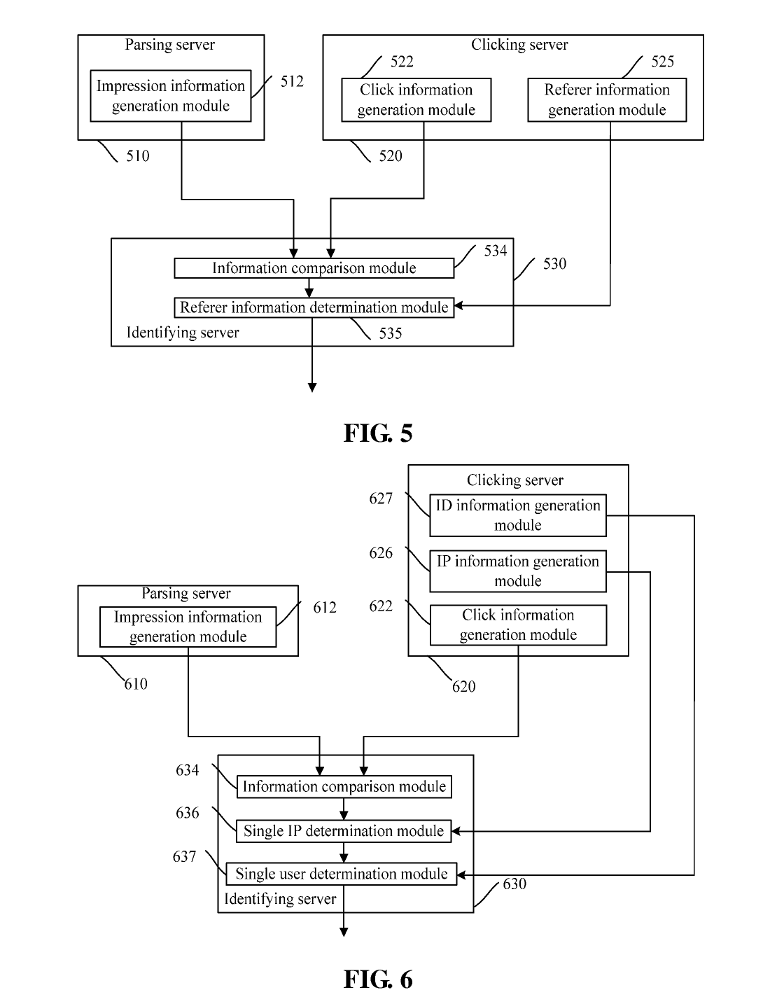

FIG. 5 is a schematic diagram illustrating a system for identifying a network click according to the third embodiment of the present invention. As show in FIG. 5, the system includes: a parsing server 510, a clicking server 520 and an identifying sever 530.

The parsing server 510 includes an impression information generation module 512, adapted to provide impression information of a page for an information comparison module 534 of the identifying server 530.

The clicking server 520 includes a click information generation module 522 and a Referer information generation module 525. The click information generation module 522 is adapted to provide click information of an impressed page for the information comparison module 534 of the identifying server 530; the Referer information generation module 525 is adapted to provide Referer information of the click for a Referer information determination module 535 of the identifying server 530.

The identifying server 530 includes the information comparison module 534 and the Referer information determination module 535.

The information comparison module 534 is adapted to determine whether the impression information and the click information meet a predefined corresponding relationship, determine the click as an effective click if the impression information and the click information meet the corresponding relationship, and determine the click as a vicious click if the impression information and the click information do not meet the corresponding relationship.

The Referrer information determination module 535 is adapted to determine whether the Referer information of the click is legal after the information comparison module 534 determines the click as an effective click, determine the click as an effective click if the Referer information is legal, and determine the click as a vicious click if the Referer information is illegal. Specifically, a URL address for impressing the clicked page is pre-configured in the Referer information determination module 535. If the Referer information of the click request equals to the URL address, the click is determined as an effective click; otherwise, the click is determined as a vicious click.

Preferably, in order to ensure information security, the clicking server 520 may further include an encryption module after the Referer information generation module 525, adapted to encrypt the Referer information and send the encrypted Referer information to the Referer information determination module 535 of the identifying server 530. In this case, the identifying server 530 further includes a decryption module before the Referer information determination module 535, adapted to decrypt the encrypted Referer information of the click request and send the decrypted Referer information to the Referer information determination module 535 for determining.

Certainly, those skilled in the art may understand that the Referer information determination module does not rely on a determining result of the information comparison module. Therefore, the Referer information determination module may also be placed ahead of the information comparison module or be used independently for identifying a network click.

As shown in FIG. 3, the method in this embodiment may further include checking the Referer information of the click request after checking the impression information and the click information. In this case, Block 301 further includes reporting the Referer information of the click request. After Block 303, regarding the click determined as an effective click, it is further determined whether the Referer information of the click request is legal, i.e. whether the Referer information equals to the URL address for impressing the clicked page, if the Referer information is legal, the click is determined as an effective click; otherwise, the click is determined as a vicious click.

Similar to the first embodiment, in this embodiment, the impression information may be the impression time of the page and the click information is the click time of the impressed page. The impression information may also be the impression user ID of the clicked page and the click information is the click user ID of the impressed page. The impression information may also be the impression time and the impression user ID of the clicked page; and the click information is the click time and the click user ID of the impressed page. The impression information may also be the impression KEY generated according to the impression time and impression user ID of the impressed page using a certain algorithm; in this case, the click information is the click KEY generated according to the click time and the click user ID of the impressed page using a certain algorithm.

### A Fourth Embodiment

In this embodiment, in order to identify the vicious click more accurately, the method may preferably further include: after checking the Referer information, restricting the maximum number of click times of a single IP address during a time unit and/or restricting the maximum umber of click times of a single user during a time unit as in the prior art.

FIG. 6 is a schematic diagram illustrating a system for identifying a network click according to the fourth embodiment of the present invention. As shown in FIG. 6, the system includes: a parsing server 610, a clicking server 620 and an identifying server 630.

The parsing server 610 includes an impression information generation module 612, adapted to provide impression information for an information comparison module 634 of the identifying server 630.

The clicking server 620 includes a click information generation module 622, an IP information generation module 626 and an ID information generation module 627.

The click information generation module 622 is adapted to provide click information of the impressed page for an information comparison module 634 of the identifying server 630.

The IP information generation module 626 is adapted to provide IP address information for a single IP determination module 636 of the identifying server 630.

The ID information generation module 627 is adapted to provide user ID information for a single user determination module 637 of the identifying server 630.

The identifying server 630 includes the information comparison module 634, the single IP determination module 636 and the single user determination module 637.

The information comparison module 634 is adapted to determine whether the impression information and the click information meet a predefined corresponding relationship, determine the click as an effective click if the impression information and the click information meet the corresponding relationship, and determine the click as a vicious click if the impression information and the click information do not meet the corresponding relationship.

The single IP determination module 636 is adapted to determine, regarding the click determined by the information comparison module 634 as an effective click, whether the number of click times of a single IP address during a time unit exceeds a predefined value, determine the click as an effective click is the number of click times does not exceed the predefined value, and determine the clicks exceeding the predefined value as vicious clicks if the number of click times exceeds the predefined value.

The single user determination module 637 is adapted to determine, regarding the click determined by the information comparison module 634 as an effective click, whether the number of click times of a single user during a time unit exceeds a predefined value, determine the clicks exceeding the predefined value as vicious clicks if the number of click times exceeds the predefined value.

Preferably, in order to ensure information security, the clicking server 620 may include an encryption module after the IP information generation module 626, adapted to encrypt the IP address information of the click request and send the encrypted IP address information to the single IP address determination module 636 of the identifying server 630. The clicking server 620 may further include an encryption module after the ID information generation module 627, adapted to encrypt ID information of the click request, and send the encrypted ID information to the single ID determination module 637 of the identifying server 630. In this case, the identifying server 630 may include a decryption module before the single IP determination module 636, adapted to decrypt the encrypted IP address information and send the decrypted IP address information to the single IP determination module 636 for determining. The identifying server 630 may further include a decryption module before the single ID determination module 637, adapted to decrypt the encrypted ID information of the click request and send the decrypted ID information to the single ID information determination 637 for determining.

As shown in FIG. 3, the method in this embodiment may preferably further include restricting a maximum number of click times of a single IP address during a time unit and/or restricting a maximum number of click time of a single user during a time unit in the prior art after checking the impression information and the click information. In this case, after Block 303, regarding the click determined as an effective click, it is further determined whether the number of click times of a single user during the time unit exceeds a predefined value, the clicks exceeding the predefined value is determined as vicious clicks if exceeds; and/or, it is determined whether the number of click times of a single IP address during the time unit exceeds the predefined value, and the clicks exceeding the predefined value is determined as vicious clicks if exceeds.

Similar to the first embodiment, in this embodiment, the impression information may be the impression time of the page, and the click information is the click time of the impressed page. The impression information may also be the impression user ID of the page, and the click information is the click user ID of the impressed page. The impression information may also be the impression time and the impression user ID of the clicked page; and in this case, the click information is the click time and the click user ID of the impressed page. The impression information may also be the impression KEY generated according to the impression time and impression user ID of the impressed page using a certain algorithm; and in this case, the click information is the click KEY generated according to the click time and the click user ID of the impressed page using a certain algorithm.

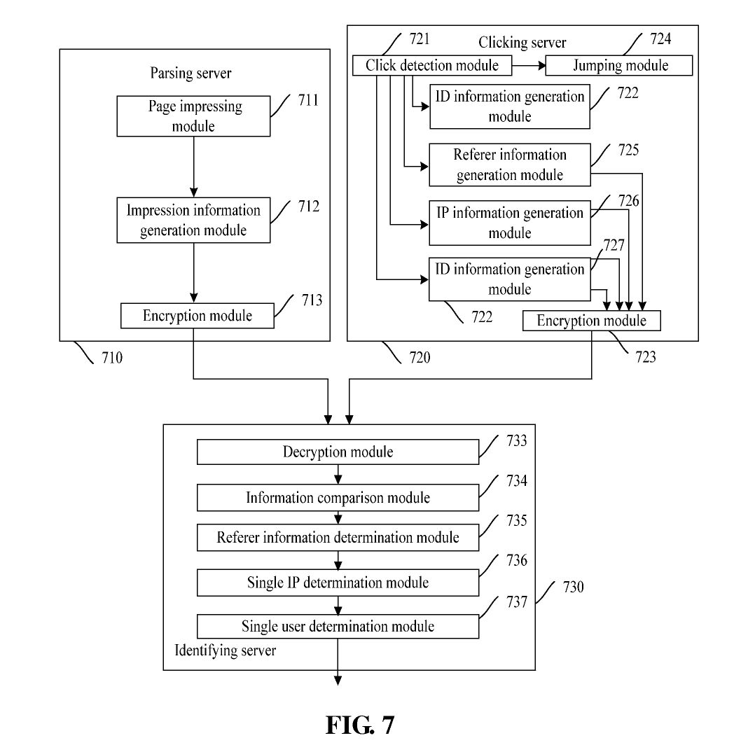

FIG. 7 is a schematic diagram illustrating a system for identifying a network click according to a fifth embodiment of the present invention. As show in FIG. 7, the system includes: a parsing server 710, a clicking server 720 and an identifying server 730.

The parsing server 710 includes a page impressing module 711, an impression information generation module 712 and an encryption module 713.

The page impressing module 711 is adapted to impress a page, e.g. impress an advertisement page on website A. Certainly, in practical applications, the page impressing module 711 may also be configured in other servers or modules outside the system of the present invention.

The impression information generation module 712 is adapted to provide impression information of the impressed page for the encryption module 713 according to an impression action of the page impressing module 711.

The encryption module 713 is adapted to encrypt the impression information sent by the impression information generation module 712, and send the encrypted impression information to an information comparison module 734 of the identifying server 730.

The clicking server 720 includes a click detection module 721, a click information generation module 722, a Referer information generation module 725, an IP information generation module 726, an ID information generation module 727, an encryption module 723 and a jumping module 724.

The click detection module 721 is adapted to detect a click on the impressed page.

The click information generation module 722 is adapted to provide click information of the impressed page for the encryption module 723 according to a click action detected by the click detection module 721.

The Referer information generation module 725 is adapted to provide Referer information of a click request for the encryption module 723.

The IP information generation module 726 is adapted to provide IP address information of the click request for the encryption module 723.

The ID information generation module 727 is adapted to provide user ID information of the click request for the encryption module 723.

The encryption module 723 is adapted to encrypt the click information of the impressed page sent by the click information generation module 722, the Referer information sent by the Referer information generation module 725, the IP address information sent by the IP information generation module 726 and the user ID information sent by the ID information generation module 727; and send the encrypted information to corresponding modules in the identifying server 730.

The jumping module 724 is adapted to perform page jumping for the clicked page after detecting a click on the impressed page. For example, when the present invention is applied to identifying an advertisement page, it jumps to a specific advertisement website. When the present invention is applied to identifying an online survey, it may jump to an online survey result page. Certainly, in practical applications, the click detection module 721 and the jumping module 724 may be configured in other servers or modules outside the system of the present invention.

The identifying server 730 includes the decryption module 733, the information comparison module 734, the Referer information determination module 735, the single IP determination module 736 and the single user determination module 737.

The decryption module 733 is adapted to decrypt the encrypted information and send the decrypted information to corresponding modules for processing. In practical applications, there may be multiple decryption modules configured in the identifying server 730.

The information comparison module 734 is adapted to receive the decrypted impression information and the decrypted click information from the decryption module 734, determine whether the impression information and the click information meet a predefined corresponding relationship, determine the click as an effective click if the impression information and the click information meet the corresponding relationship, and determine the click as a vicious click if the impression information and the click information do not meet the corresponding relationship.

The Refer information determination module 735 is adapted to receive the decrypted Referer information from the decryption module 733, determine whether the Referer information of the click request is legal after the information comparison module 734 determines the click as an effective click, determine the click as an effective click if the Referer information is legal, and determine the click as a vicious click if the Referer information is illegal.

The single IP determination module 736 is adapted to receive the decrypted IP address information of the click request from the decryption module 733, determine whether the number of click times of a single IP address during a time unit exceeds a predefined value after the information comparison module 734 determines the click as an effective click, determine the click as an effective click if the number of click times does not exceed the predefined value, and determine the clicks exceeding the predefined value as vicious clicks if the number of click times exceeds the predefined value.

The single user determination module 737 is adapted to receive the decrypted user ID information from the decryption module 733, determine whether the number of click times of a single user during a time unit exceeds a predefined value after the single IP determination module 736 determines the click as an effective click, determine the click as an effective click if the number of click times does not exceed the predefined value, and determine the clicks exceeding the predefined value as vicious clicks if the number of click times exceeds the predefined value.

Certainly, in practical applications, it may be determined according to user rules whether to adopt the Referer information technique, the maximum click times restriction technique for a single IP address in a time unit and the maximum click times restriction technique for a single user in a time unit, and it may be determined according to user rules the performing sequence of checking the corresponding relation between the impression information and the click information, the Referer information technique, the maximum click times restriction technique for a single IP address in a time unit and the maximum click times restriction technique for a single user in a time unit; the performing sequence thereof is not fixed.

Similar to the first embodiment, in this embodiment, the impression information may be the impression time of the page, and the click information is the click time of the impressed page. The impression information may also be the impression user ID of the clicked page, and in this case, the click information is the click user ID of the impressed page. The impression information may also be the impression time and the impression user ID of the clicked page; and in this case, the click information is the click time and the click user ID of the impressed page. The impression information may also be the impression KEY generated according to the impression time and impression user ID of the impressed page using a certain algorithm; and in this case, the click information is the click KEY generated according to the click time and the click user ID of the impressed page using a certain algorithm.

The present invention may be applied to various types of network click identification, e.g. identifying clicks of an online advertisement or clicks of an online survey. Accordingly, the clicked page may be an online advertisement page or an online survey page.

Hereinafter, the present invention will be described in detail by taking identifying an online advertisement as an example. Those skilled in the art may know that this embodiment is only an example of the present invention and is not used for limiting the protection scope of the present invention.

According to the impression regulation of the online advertisement and the activity habit of the user, there is regularity between the impression information of the advertisement page and the click information of the advertisement page. The regularity may be used to determine whether a click is vicious or not. For example, the playing time of the advertisement is definitely earlier than the click time of the advertisement. Therefore, the clicks earlier than the playing time of the advertisement may be regarded as vicious clicks. In addition, a click may be regarded as a vicious click if the impression user ID and the click user ID are different.

Firstly, while impressing and clicking the online advertisement, each advertisement is played following such a rule: the user opens the advertisement page first, and the advertisement is played, then the user browses and clicks the advertisement. After receiving the click, an advertisement click identification system determines whether the click is effective or vicious. If the click is effective, the click is counted during subsequent operations in order to learn the impression effect of the advertisement. Each click on the advertisement happens after the user sees the advertisement. Therefore, the impression time of the advertisement is definitely earlier than the click time of the advertisement. Any click happening before the impression time of the advertisement may be regarded as an ineffective or vicious click. Furthermore, the advertisement is generally not located where the user normally browses content information. Therefore, after the advertisement is impressed, the user generally sees the advertisement a time delay later. Therefore, the browsing habit of the user may be that the user sees the advertisement incidentally after browsing content information of a website and that the user clicks the advertisement if the user is interested in the advertisement. Thus, there should be a time delay between the click time of the advertisement and the impression time of the advertisement.

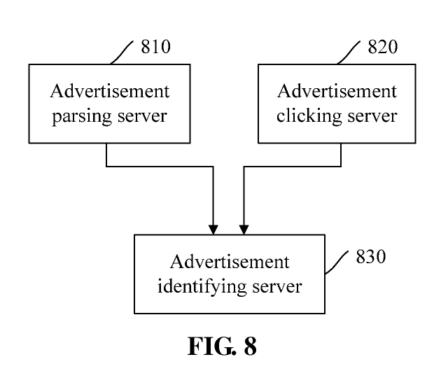

Based on the above analysis, FIG. 8 is a schematic diagram illustrating a system for identifying a network click according to an embodiment of the present invention. As shown in FIG. 8, the system includes: an advertisement parsing server 810, a clicking server 820 and an advertisement identifying server 830.

The advertisement parsing server 810 is adapted to provide, after an advertisement is impressed, impression information of the advertisement for the advertisement identifying server 830.

The advertisement clicking server 820 is adapted to provide, after the impressed advertisement is clicked, click information for the advertisement identifying server 830 according to the click.

The advertisement identifying server 830 is adapted to determine the click as an effective click if the impression information and the click information meet a predefined corresponding relation, and determine the click as a vicious click if the impression information and the click information do not meet a predefined corresponding relation.

When the user opens a website page, advertisement codes embedded in the website page are executed to send an advertisement request to the advertisement parsing server 810. After receiving the advertisement request, the advertisement parsing server 810 finds the corresponding advertisement and impresses the advertisement. For example, the user opens website page A, the advertisement parsing server 810 receives an advertisement request from website page A and impresses a Banner advertisement of company B. Meanwhile, the advertisement parsing server 810 records the current time, i.e. the impression time of the advertisement, and the current user ID, i.e. advertisement impression user ID. The advertisement parsing server 810 may also generate a unique, encrypted and reliable KEY for the advertisement request of the user according to the impression time and impression user ID using a certain algorithm. The impression KEY and the impression time indicate that the advertisement is normally played on the browser of the user. In this embodiment, although the advertisement parsing server 810 does not provide means for preventing vicious attacks directly, it can provide advertisement impression information such as the impression time and the impression user ID for the advertisement identifying server 830, and therefore the advertisement parsing server 810 is necessary.

After the user clicks the advertisement on the page, the advertisement clicking server 820 detects the click of the advertisement, and at the same time, records the current time, i.e. the advertisement click time, and the current user ID, i.e. the advertisement click user ID. The advertisement clicking server 820 may also generate a unique, encrypted and reliable KEY for the click of the user according to the advertisement click time and the advertisement user ID using a certain algorithm. After the user clicks the advertisement on the page, a click jumping service may be performed, i.e. an advertisement linkage page of company B (e.g. the website of company B) is opened. For the user, the click jumping service may be unnecessary, while for the advertisement providers, the click jumping service is a must. Only through the click jumping service can the click information of the user be “intercepted” so that the click information may be effectively identified. The click strictly follows the following three principles: “only an impressed online advertisement may have a normal click activity (effective click)”, “an online advertisement is clicked after impressed” and “user ID impressing the online advertisement is definitely the same as the user ID clicking the online advertisement”. In other words, the impression time should be earlier than the click time, there is a reasonable interval between the impression time and the click time, and the impression user ID and the click user ID are the same.

Preferably, in practical applications, time information and user ID information in the advertisement parsing server 810 and the advertisement clicking server 820 are encrypted. Moreover, interference information may be added to the time information and the user ID information. The encryption algorithm may be changed periodically. It is difficult to crack the information which is added with complicated interference information and encrypted and whose encryption algorithm and the arrangement of the interference information are changed periodically. Therefore, the security for identifying the network click is increased.

In addition, the advertisement clicking server 820 may report a Referer value of an HTTP request of the user to the advertisement identifying server 830. The advertisement identifying server 830 determines whether the Referer value is legal, i.e. whether the Referer value equals to the URL address for impressing the clicked page, and if the Referer value is illegal, closes the illegal link directly and determines the click as a vicious click.

The advertisement identifying server 830 receives relevant information reported by the advertisement parsing server 810 and the advertisement clicking server 820. The advertisement parsing server 810 mainly reports user impression information including impression time, impression user ID and impression KEY for uniquely identifying a user. The advertisement clicking server 820 mainly reports user click information including click time, click user ID, click KEY for uniquely identifying a user, Referer information, and IP information of the click request.

After receiving the above information correctly, the advertisement identifying server 830 scans the received information to identify an illegal click record, i.e. vicious click. For example, the advertisement identifying server 830 determines whether a click is vicious through scanning a maximum number of click times of each IP and/or each user during a time unit, or through determining whether the click time of the impressed advertisement page is later than the impression time of the clicked advertisement page, or through determining whether the impression user ID reported by the advertisement parsing server 810 is the same as the click user ID reported by the advertisement clicking server 820, or through determining whether the KEY reported by the advertisement clicking server 820 and the KEY reported by the advertisement parsing server 810 comply with a relevant algorithm, or through determining whether the Preferer value is legal. Each manner of identifying the vicious click is called a filter. Through filtered by the filters one by one, the rest are legal click records.

The manner of preventing vicious clicks through scanning the maximum number of click times of each IP and/or each user during a time unit is the mature technique in the prior art, and will not be described again in this embodiment.

Therefore, in embodiments of the present invention, the system for identifying a network click adequately considers the impression process of the page and the click habit of the user, and identifies a click according to the inherent corresponding relationship between the impression information and the click information, which dramatically increases the precision of the identification. After the vicious click is identified using the method provided by the present invention, it is also possible to filter the vicious click and make statistics according to the effective clicks, thereby learning how many people are interested in the online advertisement, i.e. the publishing effect of the online advertisement.

Although the online advertisement is taken as example for describing the present invention, those skilled in the art should understand that it is only an example. The present invention can be applicable to identifying any type of network clicks, and still has the same or similar effect.

To sum up, the foregoing is only preferred embodiments of the present invention and is not used for limiting the protection scope of the present invention. Any modifications, alternatives and improvements without departing from the principle of the present invention are included in the protection scope of the present invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A system for identifying a network click, comprising a parsing server, a clicking server and an identifying server;
wherein the parsing server is adapted to provide, after a page is impressed, impression information of the impressed page for the identifying server;
the clicking server is adapted to provide, after the impressed page is clicked, click information for the identifying server according to the click; and
the identifying server is adapted to determine whether the impression information and the click information meet a corresponding relationship, determine the click as an effective click if the impression information and the click information meet the corresponding relationship, and determine the click as a vicious click if the impression information and the click information do not meet the corresponding relationship.

2. The system of claim 1, wherein the impression information is impression time of the impressed page and the click information is click time of the impressed page;
the corresponding relationship is that the click time is a predefined time period later than the impression time.

3. The system of claim 1, wherein the impression information is an impression user identity ID of the impressed page and the click information is a click user ID of the impressed page;
the corresponding relationship is that the impression user ID is the same as the click user ID.

4. The system of claim 1, wherein the impression information is impression time of the impressed page and an impression user identity ID of the impressed page, and the click information is click time of the impressed page and a click user ID of the impressed page;
the corresponding relationship is that the impression time is a predefined time period later than the click time and that the impression user ID is the same as the click user ID.

5. The system of claim 1, wherein the impression information is an impression KEY generated according to impression time of the impressed page as well as an impression user identity ID of the impressed page using an algorithm;
the click information is a click KEY generated according to click time of the impressed page as well as a click user ID of the impressed page using an algorithm; and
the corresponding relationship is that the impression KEY and the click KEY comply with a KEY algorithm.

6. The system of claim 1, wherein the clicking server is further adapted to provide Peferer information of the click for the identifying server; and
the identifying server is further adapted to determine, after determining that the impression information and the click information meet the corresponding relationship, whether the click is an effective click according to the Referer information; determine the click as an effective click if the Referer information of the click equals to a Uniform Resource Locator, URL, address configured in the identifying server for page impression; and determine the click as a vicious click if the Referer information does not equal to the URL address configured in the identifying server for the page impression.

7. The system of claim 1, wherein the clicking server is further adapted to provide Internet Protocol, IP, address information of the click for the identifying server; and
the identifying server is further adapted to determine, after determining that the impression information and the click information meet the corresponding relationship, whether the number of click times of a single IP address during a time unit exceeds a predefined value; determine the click as an effective click if the number of click times does not exceed the predefined value; and determine the click as a vicious click if the number of click times exceeds the predefined value.

8. The system of claim 1, wherein the clicking server is further adapted to provide user identity ID information of the click for the identifying server; and
the identifying server is further adapted to determine, after determining that the impression information and the click information meet the corresponding relationship, whether the number of click times of a single user during a time unit exceeds a predefined value; determine the click as an effective click if the number of click times does not exceed the predefined value, and determine the click as a vicious click if the number of click times exceeds the predefined value.

9. The system of claim 1, wherein the parsing server is further adapted to encrypt the impression information before providing it for the identifying server;
the clicking server is further adapted to encrypt the click information before providing it for the identifying server; and
the identifying server is further adapted to decrypt the impression information and the click information.

10. The system of claim 1, wherein the parsing server is further adapted to impress the page.

11. The system of claim 1, wherein the clicking server is further adapted to detect the click on the impressed page, and perform page jumping after detecting the click.

12. A method for identifying a network click, comprising:
providing, after a page is impressed, impression information of the impressed page;
providing, after the impressed page is clicked, click information according to the click;
determining whether the impression information and the click information meet a corresponding relationship;
if the impression information and the click information meet the corresponding relationship, determining the click as an effective click;
otherwise, determining the click as a vicious click.

13. The method of claim 12, wherein the impression information is impression time of the impressed page, the click information is click time of the impressed page, and the corresponding relationship is that the click time is a predefined time period later than the impression time.

14. The method of clam 12, wherein the impression information is an impression user identity ID of the impressed page, the click information is a click user ID of the impressed page, and the corresponding relationship is that the impression user ID is the same as the click user ID.

15. The method of claim 12, wherein the impression information is impression time of the impressed page and an impression user ID of the impressed page;
the click information is click time of the impressed page and a click user ID of the impressed page; and
the corresponding relationship is that the impression time is a predefined time period later than the click time and that the impression user ID is the same as the click user ID.

16. The method of claim 12, wherein the impression information is an impression KEY generated according to impression time of the impressed page as well as an impression user identity ID of the impressed page using an algorithm;
the click information is a click KEY generated according to click time of the impressed page as well as a click user ID of the impressed page using an algorithm; and
the corresponding relationship is that the impression KEY and the click KEY comply with a KEY algorithm.

17. The method of claim 12, further comprising:
providing Referer information of the click;
after determining that the impression information and the click information meet the corresponding relationship, determining whether the Referer information equals to a Uniform Resource Locator (URL) address configured for page impression;
if the Referer information equals to the URL address, determining the click as an effective click;
otherwise, determining the click as a vicious click.

18. The method of claim 12, further comprising:
reporting Internet Protocol, IP, address information of the click according to the click;
after determining that the impression information and the click information meet the corresponding relationship, determining whether the number of click times of a single IP address during a time unit exceeds a predefined value;
if the number of click times does not exceed the predefined value, determining the click an effective click;
otherwise, determining the click as a vicious click.

19. The method of claim 12, further comprising:
reporting user identity ID information of the click;
after determining that the impression information and the click information meet the corresponding relationship, determining whether the number of click times of a single user during a time unit exceeds a predefined value;
if the number of click times does not exceed the predefined value, determining the click as an effective click;
otherwise, determining the click as a vicious click.

20. The method of claim 12, further comprising:
encrypting the impression information before reporting the impression information of the impressed page;
encrypting the click information before reporting the click information according to the click; and
decrypting the impression information and the click information before identifying the click.

21. The method of claim 12, further comprising:
performing page jumping after the impressed page is clicked.
